(19) United States
(12) Patent Application Publication
(10) Pub. No.: US 2019/0199165 A1
(43) Pub. Date: Jun. 27, 2019

(54) ROTATING MASS ENERGY STORE

(71) Applicant: Abigail Carson, Huntingdon Cambridgeshire (GB)

(72) Inventor: Abigail Carson, Huntingdon Cambridgeshire (GB)

(21) Appl. No.: 16/309,071

(22) PCT Filed: Jun. 6, 2017
(86) PCT No.: PCT/GB2017/051631

§ 371 Date: Dec. 11, 2018

(30) Foreign Application Priority Data
Jun. 11, 2016 (GB) 1610204.8

(51) Int. Cl. H02K 7/02; H02K 7/09; F16C 32/04

(52) U.S. Cl. CPC H02K 7/025; H02K 7/09; F16C 2361/55; F16C 32/0417; F16C 32/0414

(57) ABSTRACT

A rotating mass energy store includes a rotor that contains conductors and a magnet arrangement. The rotating mass is symmetrical about axis of rotation and is hollow with a cavity, wherein an electrical stator is located in the cavity. All components of the energy store are enclosed in a housing that has a fitting/connection for a vacuum pump and or seal, and wire connection seals for conductive wire to pass through. The rotor is permanently magnetically levitated axially and radially. Electrical energy is exchanged and stored as kinetic energy in a rotating mass, otherwise known as a rotor.

### CROSS-REFERENCE TO RELATED APPLICATIONS

This application is a national phase entry under 35 U.S.C. § 371 of International Patent Application PCT/GB2017/051631, filed Jun. 6, 2017, designating the United States of America and published in English as International Patent Publication WO 2017/212244 A1 on Dec. 14, 2017, which claims the benefit under Article 8 of the Patent Cooperation Treaty to Great Britain Patent Application Serial No. 1610204.8, filed Jun. 11, 2016.

### TECHNICAL FIELD

This disclosure relates to a rotating mass energy store.

### BACKGROUND

Energy is required to be stored so that it can be used at a later time than when it was once generated. Energy can be stored in different ways. An energy store that uses chemicals to store potential energy is harmful to the environment when it is disposed of or recycled. To overcome this problem, this present disclosure proposes kinetic energy storage without using chemicals or dangerous materials. This invention stores energy kinetically by means of a rotating mass, also known as a rotor.

### BRIEF SUMMARY

This disclosure eliminates some components that are in existing rotary energy storage designs, which reduces material usage and increases energy and power density. Natural properties of materials are utilized to form a more effective and efficient energy store that does not harm the environment.

In accordance with this disclosure, there is provided a rotary energy store comprising a permanently magnetically levitated rotor.

In one embodiment, the permanently magnetically levitated rotor is part of an integrated motor-generator unit.

In one embodiment, the permanent magnetic levitation system comprises radial permanent magnetic bearings.

In one embodiment, the permanent magnetic levitation system comprises axial permanent magnetic bearings.

In one embodiment, the radial permanent magnetic bearings are electrodynamic bearings.

In one embodiment, the axial permanent magnetic bearings use Halbach array magnet arrangements to produce levitation forces.

In one embodiment, the rotor is in a sealed housing. The sealed housing may have a connected vacuum pump to form a vacuum environment for the rotor to rotate in.

In one embodiment, the housing secures one or more of (e.g. two or more of or all of): the stator of the motor-generator unit; the magnets of the radial electrodynamic bearings; and the axial permanent magnetic bearings.

In one embodiment, the stator is located equidistant between both axial permanent magnetic bearings.

In one embodiment, the rotor is a hollow body (e.g., hollow symmetrical body). In one embodiment, the hollow body contains embedded magnets in its wall that form part of the motor-generator unit.

In one embodiment, the hollow body contains embedded conductors that form part of complete radial electrodynamic bearings and/or part of complete axial permanent magnetic bearings.

In one embodiment, the magnets embedded in the rotor rotate about the stator and are also equidistant between both axial permanent magnetic bearings.

In one embodiment, the conductors for the radial electrodynamic bearings are located such that the conductors are aligned with the radial bearing magnets (e.g., so the conductor within the wall rotates about the radial bearing magnets secured by the housing).

In one embodiment, the conductors for the axial permanent magnetic bearings are located such that the conductor is embedded in the rotor at the rotor's open end, so the sequence of arrangement is: rotor with embedded conductor, a gap, the axial permanent magnet arrangement that is secured in place by the housing. This sequence may change direction but remains in the same order as the arrangement will be at both ends of the rotor.

In one embodiment, the rotary energy store disclosed herein has a rotor that is magnetically levitated axially and radially.

The rotor may have a hollow structure that is symmetric axially and radially, it has the majority of its mass at its circumference and contains magnets and conductors within its wall. In one embodiment, these magnets in the rotor wall are part of an integrated motor-generator unit where the rotor is forced to rotate about an electrical stator owing to induction.

The magnets within the wall of the rotor may have a polarization sequence that forms a Halbach array producing an augmented magnetic field in the inner cavity of the rotor where the stator is located. An integrated motor-generator unit means that the motor-generator is not a separate part from the rotor; the rotor is used to be part of the motor-generator unit.

In one embodiment, the rotor is made of a composite material.

In one embodiment, the electrical stator is static. The stator may have multiple poles, which are extended parts of the geometry and are equally spaced radially. Each pole may hold a coil winding. A coil winding is where electrically conductive wire is wrapped around the bulk of the pole multiple times. Each coil winding has “tails” that are where the coil begins and where the coil ends. When electrical current is conducted by the conductive wire of the coil windings, by induction, the rotor is forced to rotate about the stator. Depending on the direction of the current, the rotor will be forced to rotate faster relative to prior motion or rotate slower relative to prior motion. When electrical current is drawn from the coil winding wire, leaving the energy store, the rotor will slow down. When electrical current is applied to the wire, going into the energy store, the rotor will rotate faster.

In one embodiment, the stator is made of iron. In one embodiment, the electrically conductive wire is made of copper.

In one embodiment, a housing structure encloses all moving parts of the energy store. The housing may possess a fitting that is able to connect a vacuum pump and or vacuum system and or vacuum seal so that a vacuum or low-pressure environment can be created within the housing cavity.

The housing may secure the location of the magnets and iron pole shoes of the radial electrodynamic bearings and the magnets of the axial permanent magnetic bearings; this may be by means of brackets or similar fixing preferably made from a non-conducting material.

In one embodiment, the coil winding tails extend to the housing and through a seal so that electrical current can be exchanged to and from the energy store, but without air leakage.

In one embodiment, the axial and radial levitation magnetic bearings are both permanent magnetic bearings.

In one embodiment, the radial magnetic bearings prevent gyration about the axis of rotation and contact between stationary and moving parts of the energy store. In one embodiment, the radial magnetic bearings are electrodynamic bearings, comprising a hollow cylindrical stack of alternating iron rings and ring magnets, the stack sequence beginning and ending with iron rings, which may be known as iron pole shoes. The iron pole shoes and ring magnets may have the geometry of a shallow hollow cylinder.

In one embodiment, a conductor is embedded in the wall of the rotor aligned with the location of the electrodynamic bearings, which gives rise to repulsive forces between the conductor itself and the electrodynamic bearing, levitating and stabilizing the rotor. As the electrodynamic bearings are located near the ends of the rotor, the conductor for the electrodynamic bearing will be located in the wall of the rotor so that it aligns with the electrodynamic bearings. Each electrodynamic bearing may have at least one conductor that is embedded in the wall of the rotor.

In one embodiment, axial magnetic bearings prevent touchdown of the rotor.

Touchdown is where levitation is lost and the rotor falls (possibly while rotating) and hits a static part of the energy store. In one embodiment, the axial magnetic bearings are arrangements of permanently polarized magnet segments that form a ring shape. The sequence of polarized magnets may be in the form of a Halbach array where the augmented field is where the rotor is located, wherein a conductor is embedded in the rotor wall. Repulsive forces arise between the conductor embedded in the rotor wall and the arrangement of polarized magnets. As the axial magnetic bearings are located at the extremities of the rotor length, the conductor in the rotor wall will be located close to the rotor end(s). The conductor can be in the form of a torus or coil, or a combination of both, and can be made from more than one piece.

A Halbach array is a sequence of magnets with a particular polarization pattern. The sequence is of magnets that are alternatively polarized laterally and longitudinally. However, the longitudinally polarized magnets alternatively change polarity. The laterally polarized magnets also alternatively change polarity. The base sequence is four magnets long, and this sequence repeats. This sequence can be formed into a geometrical shape but the relative sequence/pattern remains.

### BRIEF DESCRIPTION OF THE DRAWINGS

An embodiment of the present disclosure will now be described solely by way of example and reference to the accompanying drawings in which:

FIG. 1 is an array sequence according to one embodiment of this disclosure;

FIG. 2 is a cross-sectional view of the electrodynamic bearing according to one embodiment of this disclosure;

FIGS. 3A and 3B illustrate the axial permanent magnetic bearing according to one embodiment of this disclosure with FIG. 3A being a cross-sectional view and FIG. 3B being a top view;

FIG. 3C is a top view of the torus conductor of FIG. 3A according to one embodiment of this disclosure;

FIG. 4A is a cross-sectional view of a rotor with its embedded magnets and conductors according to one embodiment of this disclosure;

FIG. 4B is a top view of the rotor magnets of FIG. 4A illustrating their polarization direction according to one embodiment of this disclosure;

FIG. 5A shows the top view of the electrical stator according to one embodiment of this disclosure;

FIG. 5B illustrates the conductive wire of FIG. 5A wrapped around the pole piece according to one embodiment of this disclosure;

FIG. 5C illustrates the pole piece of FIG. 5A with the conductive wire of FIG. 5A wrapped around it according to one embodiment of this disclosure; and

FIG. 6 illustrates the rotary energy store with a majority of its components according to one embodiment of this disclosure.

### DETAILED DESCRIPTION

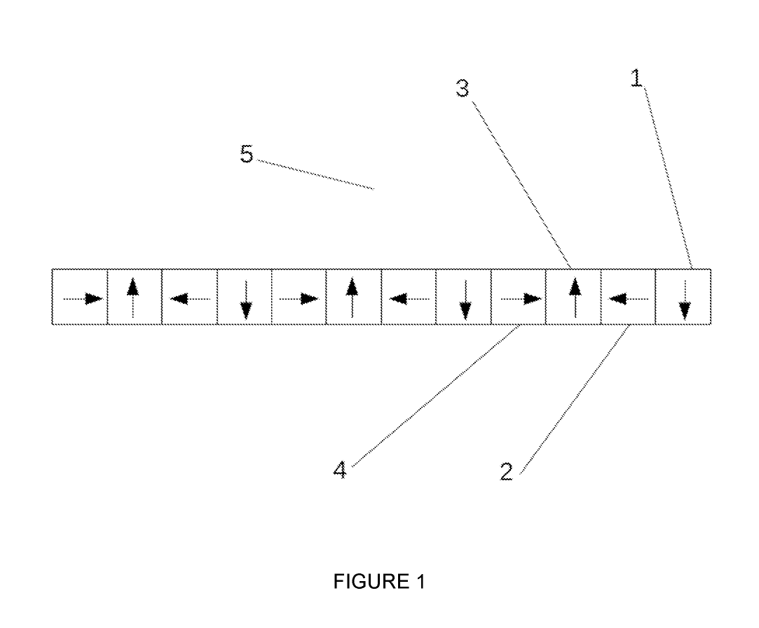

FIG. 1 shows a Halbach array sequence wherein an augmented magnetic field 5 includes longitudinally polarized magnets 2 and 4, alternating in direction, and laterally polarized magnets 1 and 3, alternating in direction. The magnets 1-4 are equal in size.

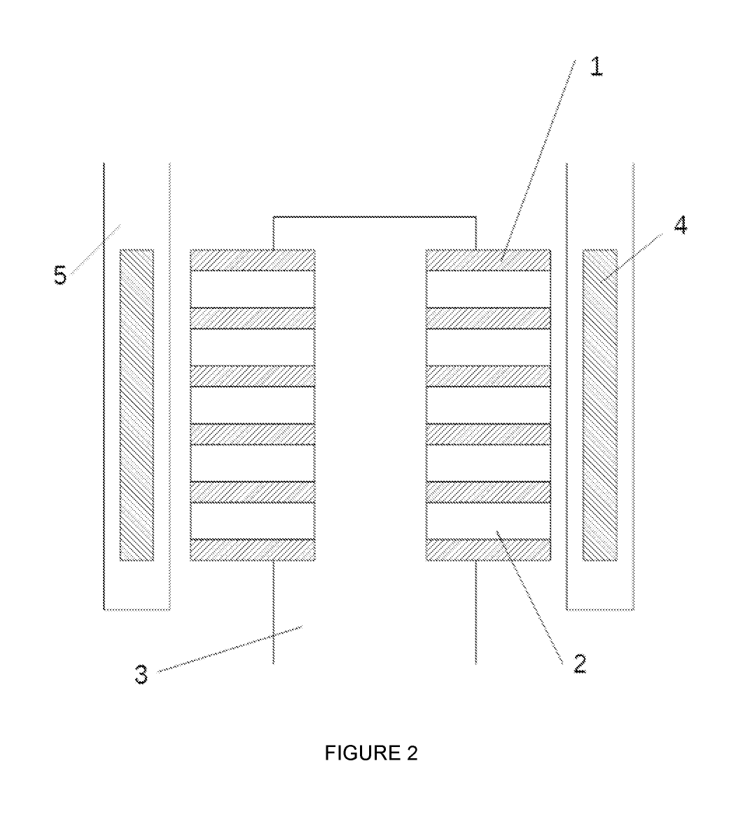

FIG. 2 is a cross-sectional view of the electrodynamic bearing that provides radial stability and levitation. The interacting conductor and securing shaft/bracket are also shown in cross-sectional view, as if they were cut in half down the center. (1) Iron pole shoes are ring shape and show (2) ring magnets, with a (3) securing shaft that is attached to or part of the housing, (4) with conductor embedded in the rotor wall, (5) of the rotor.

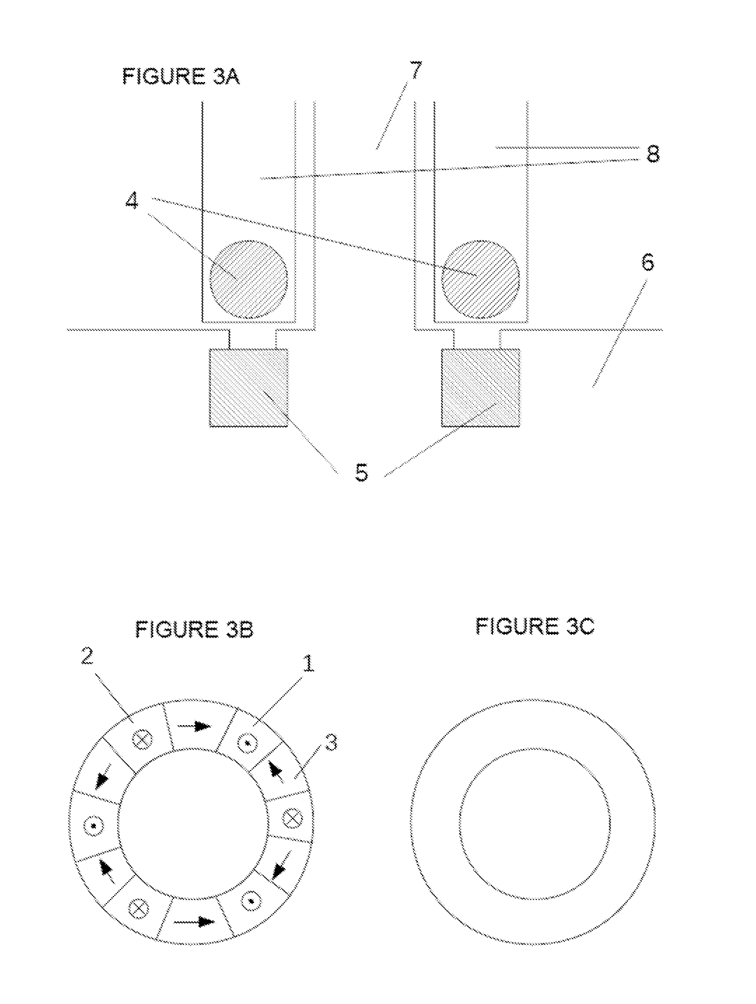

FIGS. 3A and 3B show the axial permanent magnetic bearing with its interacting conductor and securing method, shown in cross-sectional view. In FIG. 3A, a cross-sectional view of the axial permanent magnetic bearing and the securing method is shown, where (5) is the cross section for the magnet ring which comprises small ring magnet segments, (6) a part of the housing partially enclosing the axial permanent magnetic bearing that comprises magnet segments, (7) the shaft attached to or part of the housing that leads to securing other components, (4) is the torus conductor, which can be solid or coil shaped, and (8) the rotor wall. The housing section (6) is of a geometry that partially encloses the axial permanent magnetic bearing (5), (7) is a section which can be part of the same body of (6) which can lead to securing the electrodynamic bearing and stator. The torus conductor (4) is embedded in the rotor wall (8). The rotor (8) includes the embedded torus conductor (4) to levitate about the axial permanent magnetic bearing (5) which is secured in place by (6).

FIG. 3B shows the top view of the axial permanent magnetic bearing of (5, FIG. 3A). The segments that form the “ring” are shown with their polarization directions.

Every other magnet is polarized tangentially, and every other magnet is polarized either into or out of the paper, labelled as (2) and (1) respectively. The tangentially polarized magnets (3) alternate in the tangential direction. The magnets with polarization direction into the paper are labelled (2). The magnets with polarization direction out of the paper are labelled (1).

FIG. 3C shows the top view of the torus conductor (4).

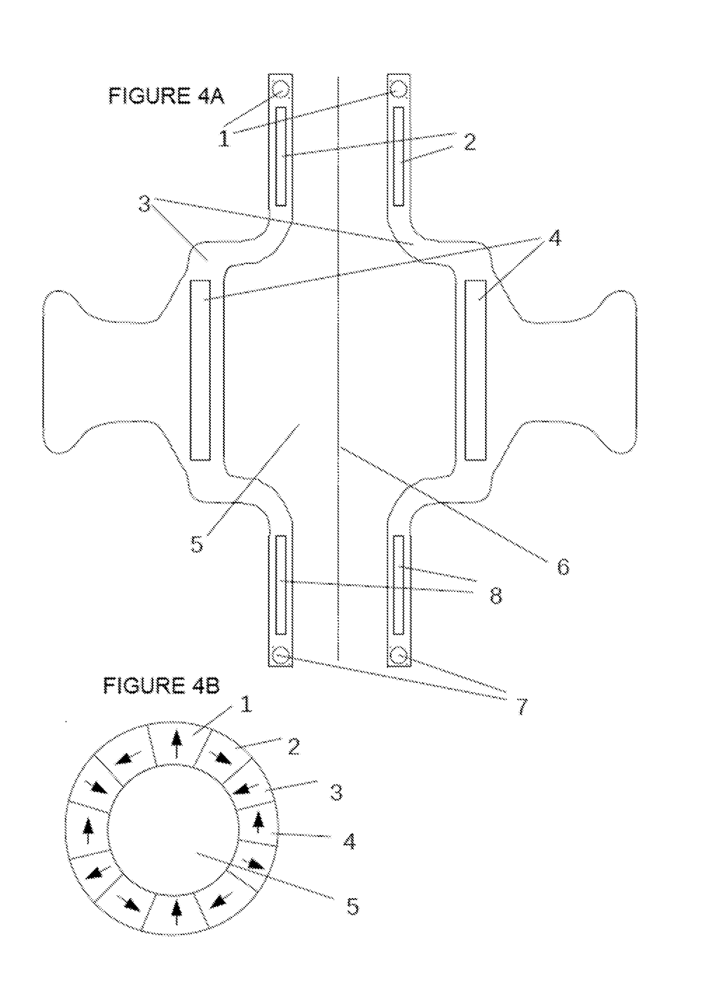

FIG. 4A represents a rotor with its embedded magnets and conductors. Torus conductor (1) and radial conductor (2) are embedded in the rotor wall (3), rotor magnets (4) are embedded in the wall of the rotor near the inner surface of the rotor cavity (5) where the electrical stator would be located.

FIG. 4B shows the top view of the rotor magnets and their polarization direction. The polarization pattern comprises tangentially polarized magnets and radially polarized magnets. The pattern alternates between tangentially and radially polarized magnets, and these alternate too. (1) and (2) are both radially polarized but are in opposing directions, where (1) is polarized toward the circumference of the ring, and (2) is polarized toward the center of the ring. (3) and (4) are both tangentially polarized magnets, but are polarized in opposite directions. The base sequence comprises of (1), (2), (3) and (4) which repeats to form the pattern. The polarization pattern of magnets creates an augmented magnetic field on the inside of the ring, labelled (5).

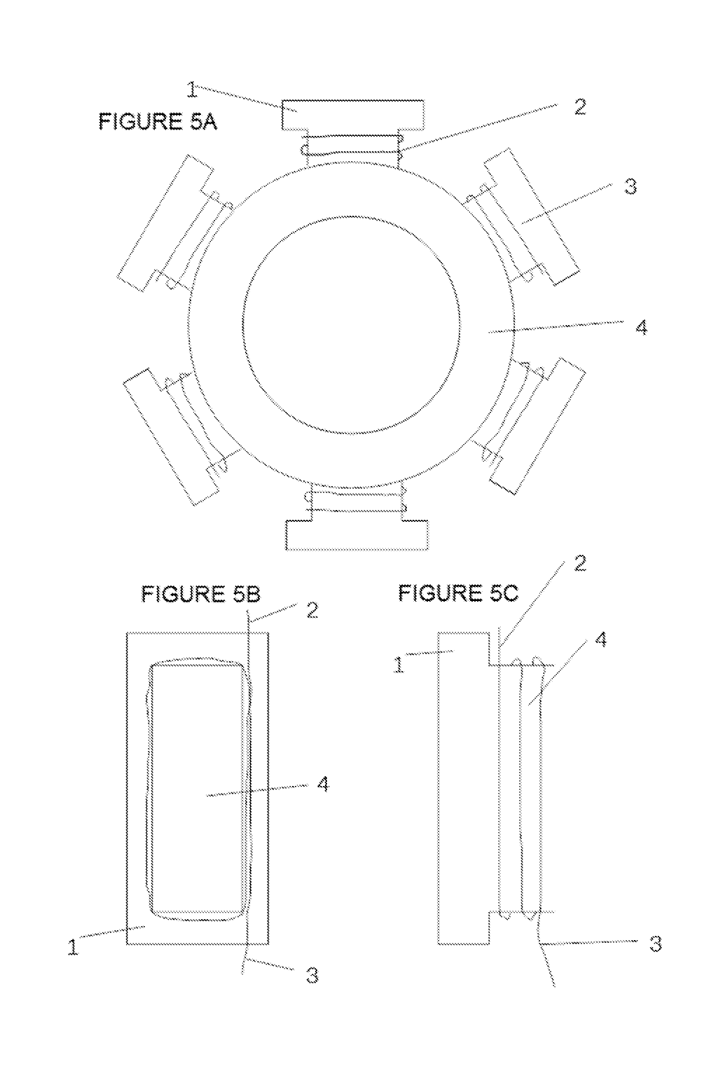

FIG. 5A is a top view of an electrical stator. (1), the pole head, (2), electrically conductive wire, (3) pole piece, (4) the stator core. The stator has more than one pole, usually five or six. The poles are equally spaced around the stator core (4). Each pole piece (3) has a pole head (l), the conductive wire (2) is wrapped around the pole piece (3) for at least one complete turn, but can have multiple turns.

FIG. 5B illustrates how the conductive wire (2 of FIG. 5 A) is wrapped around the pole piece (3 of FIG. 5A). In FIG. 5B, (1) is the pole head, (4) is the pole piece, and (2) and (3) show the coil “tails.” The coil tails (2) and (3) are extensions of the conductive wire that extend from where the coil starts and where the coil ends, in other words, where the coil leads to the coil and leaves the pole piece (4).

FIG. 5C shows the pole piece (3 of FIG. 5 A) and how the conductive wire (2 of FIG. 5A) wraps around it. In FIG. 5C, (1) is the pole head, (4) is the pole piece and (2) and (3) are the coil “tails.” The conductive wire wraps around the pole piece (4) for two whole turns and leaves the pole piece with the coil tail extension (3).

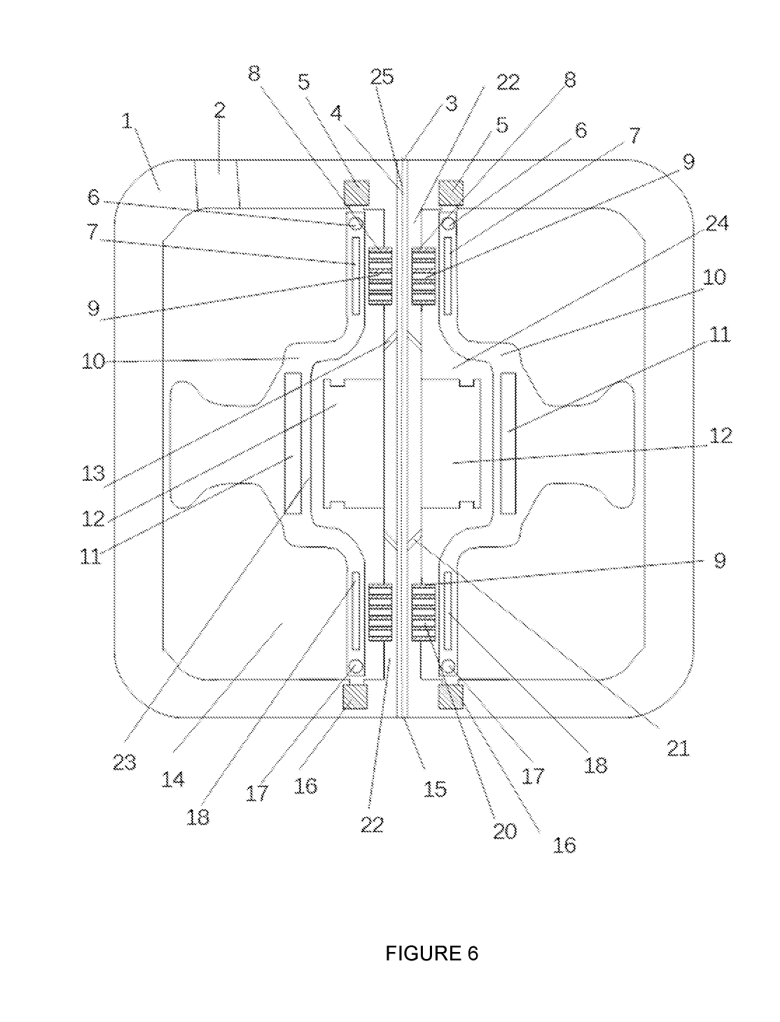

FIG. 6 shows the rotary energy store with the majority of its components. (1) the housing, can have a fitting or connection (2) that can connect with a vacuum pump and or seal (not shown) that is able to create a vacuum environment within the cavity of the housing (14).

The housing (1) also has at least one seal that holds a wire through the housing and does not allow air leakage to occur to or from the energy store. FIG. 6 shows the housing with two wire seals (3) and (15).

The housing (1) has a cavity (14) where most of the components go, and where the vacuum environment is created.

The housing (1) has a shaft (22) that is through its center, with a channel (4), and at either end of the shaft are two wire seals (3) and (15).

The shaft (22) has additional small channels (13) and (21) that allow the coil tails of (2 and 3 of FIG. 5B) to go from the poles of the stator (12) through to the center channel (4) of the shaft (22) and to the wire seals (3) and (15), that then leave the energy store for energy exchange.

The shaft (22) secures the stator (12) in place.

The stator (12) is located on the shaft (22) in the housing (1) so that it is equidistant from either axial magnetic bearing.

The housing (1) secures the location of the axial magnet bearing rings (5) and (16) by means of geometry of the housing.

The rotor (10) is levitated within the housing cavity (14) about the shaft (22), between the axial magnets (5) and (16) and about the electrodynamic bearings, which comprises multiple iron pole shoes (8) and (19) and multiple ring magnets (9) and (20), which are stacked alternatively, and explained with reference to FIG. 2. The electrodynamic bearings are secured in place on the shaft (22).

The rotor (10) has components embedded in its wall. The rotor (10) has open ends so that it can rotate about the electrodynamic bearing that is secured by a shaft. Two torus conductors (6) and (17) are embedded in the rotor wall at the extremities of the rotor (10). Two conductors (7) and (18) are embedded in the rotor wall for each radial electrodynamic bearing, and are embedded so that they are aligned with the electrodynamic bearing. The rotor (10) also has magnets (11) embedded in its main bulk near the inner surface (23) of the rotor cavity (24). The rotor magnets (11) are located such that they are aligned with the stator (12) for interaction to occur.

1. A rotary energy store comprising at least one permanently magnetically levitated rotor.

2. The rotary energy store according to claim 1, wherein the at least one permanently magnetically levitated rotor is part of an integrated motor-generator unit.

3. The rotary energy store according to claim 2, wherein the at least one permanently magnetically levitated rotor comprises radial permanent magnetic bearings and axial permanent magnetic bearings.

4. The rotary energy store according to claim 3, wherein the radial permanent magnetic bearings are electrodynamic bearings and the axial permanent magnetic bearings use Halbach array magnet arrangements to produce levitation forces.

5. The rotary energy store according to claim 4, wherein the at least one permanently magnetically levitated rotor is in a sealed housing that can have a connected vacuum pump to form a vacuum environment in which the at least one permanently magnetically levitated rotor rotates during operation.

6. The rotary energy store according to claim 5, wherein the housing secures a stator of the integrated motor-generator unit and the magnets of the radial electrodynamic bearings and the axial permanent magnetic bearings.

7. The rotary energy store according to claim 6, wherein the stator is located equidistant between both axial permanent magnetic bearings.

8. The rotary energy store according to claim 7, wherein the at least one permanently magnetically levitated rotor is a hollow symmetrical body that contains embedded magnets in its wall that form part of the integrated motor-generator unit and also contains embedded conductors that form part of complete radial electrodynamic bearings and part of complete axial permanent magnetic bearings.

9. The rotary energy store according to claim 8, wherein the magnets embedded in the at least one permanently magnetically levitated rotor rotate about the stator and are also equidistant between both axial permanent magnetic bearings.

10. The rotary energy store according to claim 9, wherein the conductors for the radial electrodynamic bearings are located such that the conductors are aligned with the radial bearing magnets, so the conductor within a wall rotates about the radial bearing magnets secured by the housing.

11. The rotary energy store according to claim 10, wherein the conductors for the axial permanent magnetic bearings are located such that the conductor is embedded in the rotor at the rotor's open end, so the sequence of arrangement is: rotor with embedded conductor, a gap, the axial permanent magnet arrangement, which is secured in place by the housing.
